(19) United States
(12) Patent Application Publication
(10) Pub. No.: US 2019/0359462 A1
(43) Pub. Date: Nov. 28, 2019

(54) SKIRT ASSEMBLY FOR BASKET OF AERIAL WORK PLATFORM

(71) Applicant: MCF Distributing, LLC, Mill Creek, WA (US)

(72) Inventor: Mark S. Mueller, SeaTac, WA (US)

(73) Assignee: MCF Distributing, LLC, Mill Creek, WA (US)

(21) Appl. No.: 16/418,056

(22) Filed: May 21, 2019

Related U.S. Application Data
(60) Provisional application No. 62/676,106, filed on May 24, 2018.

(51) Int. Cl. B66F 17/00; B66F 11/04

(52) U.S. Cl. CPC B66F 17/006; B66F 11/04

(57) ABSTRACT

Disclosed embodiments include skirt assemblies for baskets of aerial work platforms, methods of fabricating a skirt assembly for a basket of an aerial work platform, and methods of attaching a skirt assembly onto a basket of an aerial work platform. In an illustrative embodiment given by way of non-limiting example, a skirt assembly for a basket of an aerial work platform includes attachment devices that are removably attachable to a basket of an aerial work platform. Each of the plurality of attachment devices is configured to extend outwardly from the basket substantially normally to the basket. A flexible cover is configured to be removably attachable to the plurality of attachment devices such that the flexible cover is extendable substantially normally about exterior sides of at least a portion of a basket of an aerial work platform.

### RELATED APPLICATION

The present application claims the benefit of priority of the filing date of U.S. Provisional Patent Application Ser. No. 62/676,106, filed May 24, 2018 and entitled “SKIRT ASSEMBLY FOR BASKET OF AERIAL WORK PLATFORM,” the entire contents of which are hereby incorporated by reference.

### TECHNICAL FIELD

The present disclosure relates to accessories for aerial work platforms.

### BACKGROUND

An aerial work platform is a mechanical device used to provide temporary access for people or equipment to inaccessible areas, usually at height. Aerial work platforms are generally used for temporary, flexible access purposes such as maintenance and construction work, such as among other things performing planned maintenance items, performing repairs, painting, cleaning, and the like.

One type of aerial work platform is known as a boom lift (sometimes referred to as a “cherry picker”). A boom lift includes a mobile base unit with a boom extending therefrom. The boom may have any number of sections as desired. The sections may be articulating or telescoping.

A basket is attached to the end of the boom. In a typical boom lift, a mounting bracket is attached to the end of the boom. A vertical member extends vertically downwardly from the mounting bracket. Horizontal members (such as forks) extend horizontally from the vertical member. The basket is attached, such as by being bolted, onto a distal end of the horizontal members.

Another type of aerial work platform is known as a scissor lift. A scissor lift includes a mobile base unit with a lifting mechanism extending vertically therefrom. The lifting mechanism includes members connected in a scissor-like manner. A basket is attached onto a distal end of the lifting mechanism. The basket is raised or lowered, as desired, by causing the lifting members to engage each other in a scissor-like manner.

The basket includes guard rails and a control panel for controlling functions such as raising and lowering the basket, rotating the basket (when attached to a boom lift), driving and steering the mobile base unit, and the like. The basket also includes a floor. A foot-operated master switch for the control panel is mounted on the floor. The floor typically is made from an expanded metal grate. Decals are attached to various surfaces of the basket to convey information, cautions, and warnings, and to identify various features. Various hardware and/or tools may be contained in the basket.

Sometimes, workers located in a basket may perform work outside guard rails of the basket. In such circumstances, if a tool, part, workpiece, component, consumable, or other item being used in a maintenance or construction action were dropped, then the dropped item may fall out of the sides of the basket toward the ground. While falling toward the ground, the dropped part may impact items installed in a facility (such as video screens, loudspeakers, seats, and the like), facility structure, facility walls, and the like. Such impacted items and/or structure may become dislodged and may, in turn, fall toward the ground. The dropped part and/or impacted items and/or structure may result in damage to the item, damage to items installed in a facility, damage to facility structure, walls, and/or floor, and/or injury to a person or persons who may be struck by any one or more of such falling items.

### SUMMARY

Disclosed embodiments include skirt assemblies for baskets of aerial work platforms, methods of fabricating a skirt assembly for a basket of an aerial work platform, and methods of attaching a skirt assembly onto a basket of an aerial work platform.

In an illustrative embodiment given by way of non-limiting example, a skirt assembly for a basket of an aerial work platform includes attachment devices that are removably attachable to a basket of an aerial work platform. Each of the plurality of attachment devices is configured to extend outwardly from the basket substantially normally to the basket. A flexible cover is configured to be removably attachable to the plurality of attachment devices such that the flexible cover is extendable substantially normally about exterior sides of at least a portion of a basket of an aerial work platform.

In another illustrative embodiment given by way of non-limiting example, a non-limiting, illustrative method of attaching a skirt assembly onto a basket of an aerial work platform includes: removably attaching a plurality of attachment devices to a basket of an aerial work platform, each of the plurality of attachment devices being configured to extend outwardly from the basket substantially normally to the basket; and removably attaching a flexible cover to the plurality of attachment devices such that the flexible cover is extendable substantially normally about exterior sides of at least a portion of a basket of an aerial work platform.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the text (e.g., claims and/or detailed description) and/or drawings of the present disclosure.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a perspective view of an illustrative skirt assembly attached to a basket of an aerial work platform.

FIG. 2A is a side perspective view of an illustrative bracket of the skirt assembly of FIG. 1.

FIG. 2B is a perspective view of an illustrative support arm of the skirt assembly of FIG. 1.

FIG. 2C is a perspective view of a support arm that is rotatably removably attached to its associated bracket of the skirt assembly of FIG. 1.

FIG. 2D is a side plan view of a linch pin of FIG. 2C.

FIG. 2E is a perspective view of one support arm that is rotatably removably attached to its associated bracket at one attachment point.

FIG. 2F is a perspective view of one support arm that is rotatably removably attached to its associated bracket at two attachment points.

FIG. 2G is a perspective view of two support arms that are rotatably removably attached to their associated bracket.

FIG. 3A is a perspective view of an illustrative suspension tube of the skirt assembly of FIG. 1.

FIG. 3B is a perspective view of an illustrative flexible panel of the skirt assembly of FIG. 1.

FIG. 3C is a perspective view of an illustrative bracket that is removably attached to a panel.

FIG. 3D is a perspective view of another illustrative flexible panel of the skirt assembly of FIG. 1.

FIG. 3E is a perspective view of another illustrative flexible panel of the skirt assembly of FIG. 1.

FIG. 3F is a perspective view of another illustrative flexible panel of the skirt assembly of FIG. 1.

FIG. 3G is a perspective view of another illustrative flexible panel of the skirt assembly of FIG. 1.

FIG. 3H is a perspective view of another illustrative flexible panel of the skirt assembly of FIG. 1.

FIG. 3I is a perspective view of another illustrative flexible panel of the skirt assembly of FIG. 1.

FIG. 3J illustrates details of the flexible panel of FIG. 3I.

FIGS. 3K and 3L are perspective view of another illustrative flexible panel of the skirt assembly of FIG. 1.

FIG. 4A illustrates details of flexible panels of the skirt assembly of FIG. 1.

FIGS. 4B-4E illustrate lifting flexible panels and temporarily attaching flexible panels to guardrails of a basket of an aerial work platform.

The use of the same symbols in different drawings typically indicates similar or identical items unless context dictates otherwise.

### DETAILED DESCRIPTION

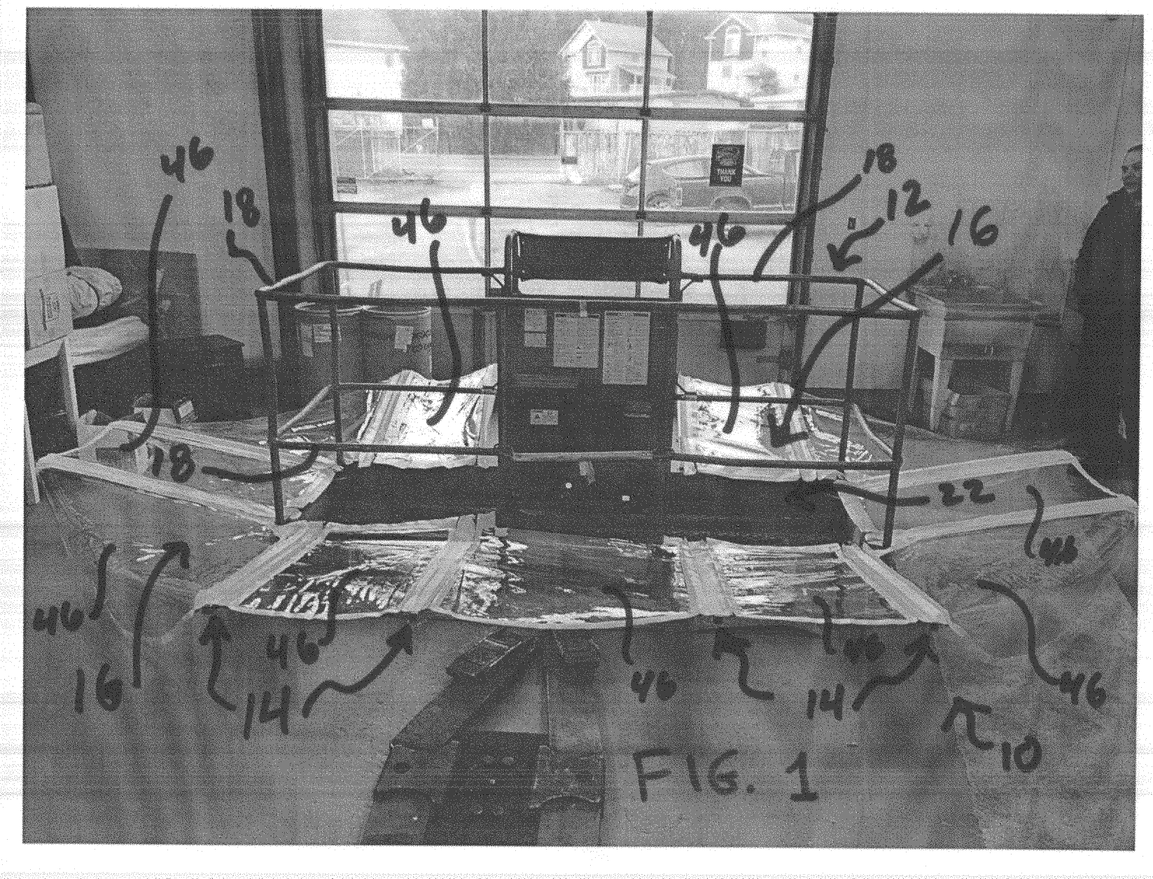

Given by way of non-limiting overview and referring to FIG. 1, an illustrative skirt assembly 10 for a basket 12 of an aerial work platform (not shown) includes attachment devices 14 that are removably attachable to the basket 12. Each of the attachment devices 14 is configured to extend outwardly from the basket 12 substantially normally to the basket 12. A flexible cover 16 is configured to be removably attachable to the attachment devices 14 such that the flexible cover 16 is extendable substantially normally about exterior sides of at least a portion of the basket 12

Still by way of overview, in various embodiments the skirt assembly 10 is configured for use with an aerial work platform such as a boom lift (also referred to as a “cherry picker”) or a scissor lift. As is known, the aerial work platform may be used for temporary, flexible access purposes such as maintenance and construction work. As such, workers in the basket 12 may perform tasks such as, without limitation, such as among other things performing planned maintenance items, performing repairs, painting, cleaning, and the like. As is also known, the basket 12 has an a weight limit for workers, tools, and parts. For example, a typical weight limit may be on the order of around 500 pounds, depending on the basket 12.

Sometimes, workers located in the basket 12 may perform work outside guard rails 18 of the basket 12. In such circumstances, if a tool, part, workpiece, component, consumable, or other item being used in a maintenance or construction action were dropped, then the dropped item may impact the cover 16. In some circumstances, the dropped tool, part, workpiece, component, consumable, or other item may be retained on a top surface of the cover 16 (depending on weight and/or impact force of the dropped item), thereby acting as a “floor” member that holds up the dropped item. Thus, the skirt assembly 10 may help reduce the likelihood that dropped items may fall out the basket 12 toward the ground. As a result, the skirt 10 assembly may, in turn, help reduce the likelihood that dropped items may damage items installed in a facility, damage facility structure, walls, and/or floor, and/or injure a person or persons who may be struck by any one or more of such falling items.

Still by way of overview and in some other instances, a sufficient-enough impact force or weight of the dropped item may cause a portion of the flexible cover 16 to detach from associated attachment devices 14. For example, maintenance may be performed on a heavy workpiece, such as without limitation an electric motor (which may weigh on the order of 150 pounds or so) or the like, that is part of a facility and is not placed in the basket. In such a circumstance, if the workpiece were to fall onto the flexible cover then (depending on the weight of the dropped item) a portion of the flexible cover 16 to detach from associated attachment devices 14. Thus, the associated attachment devices serve as weak links that provide a breakaway function. Illustrative reasons for providing such weak links include preventing the skirt assembly from retaining an item that, if retained outside the basket on the flexible cover 16, could cause a weight limit of the basket 12 to be exceeded or that could cause the basket 12 to tilt.

Details will be set forth below by way of illustrative examples and not of limitation.

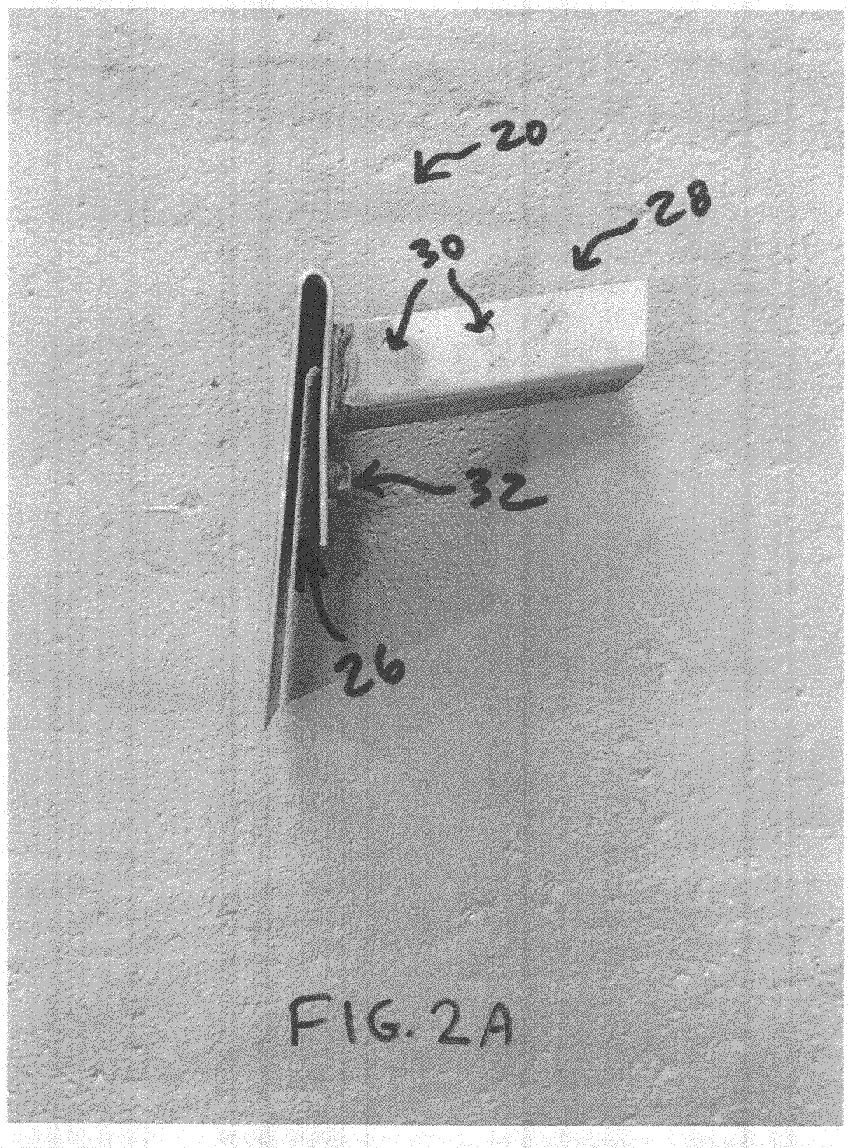

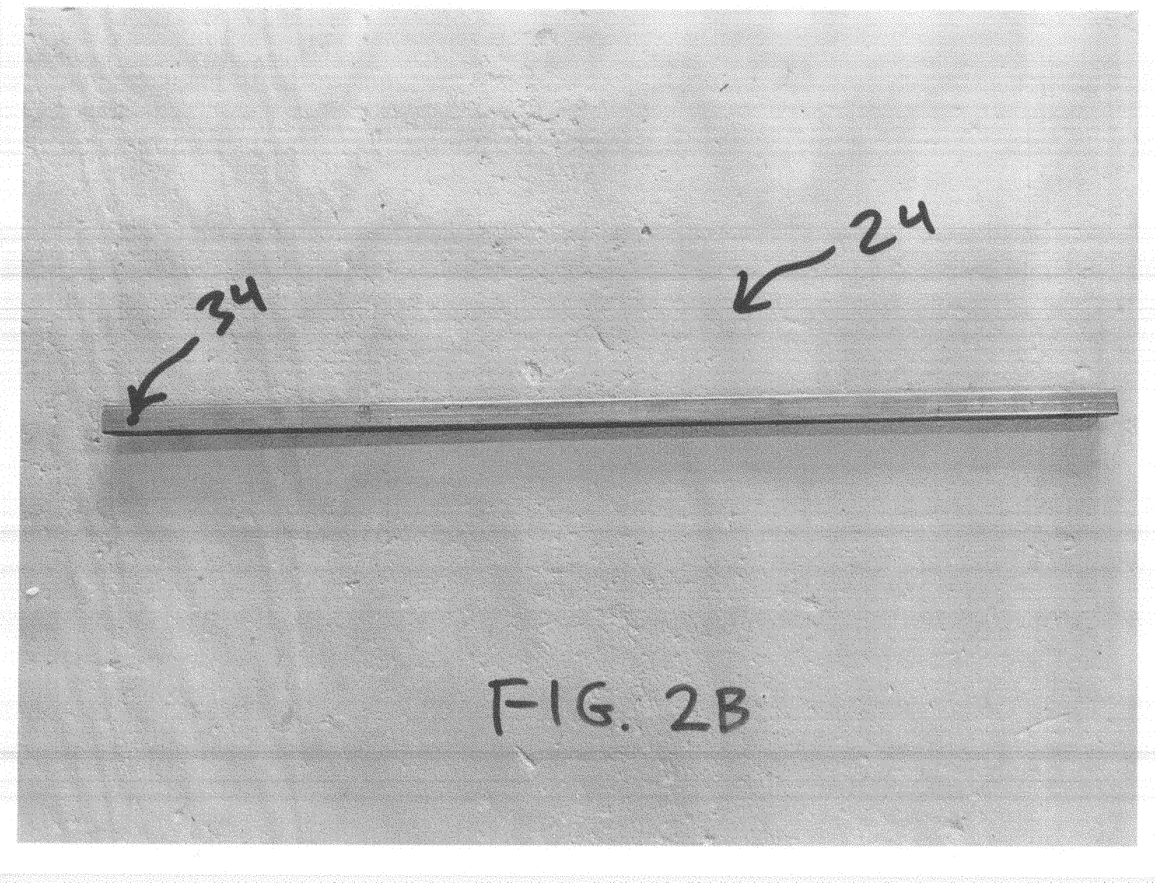

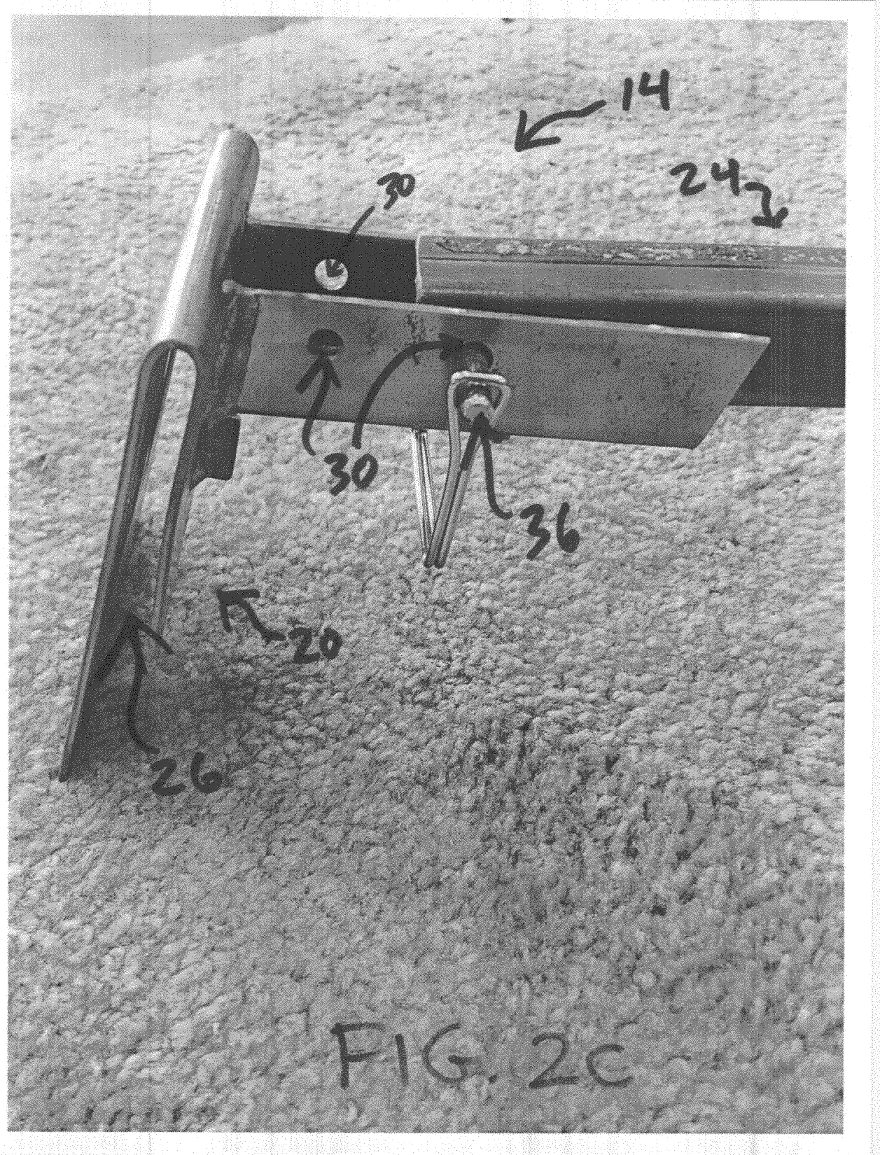

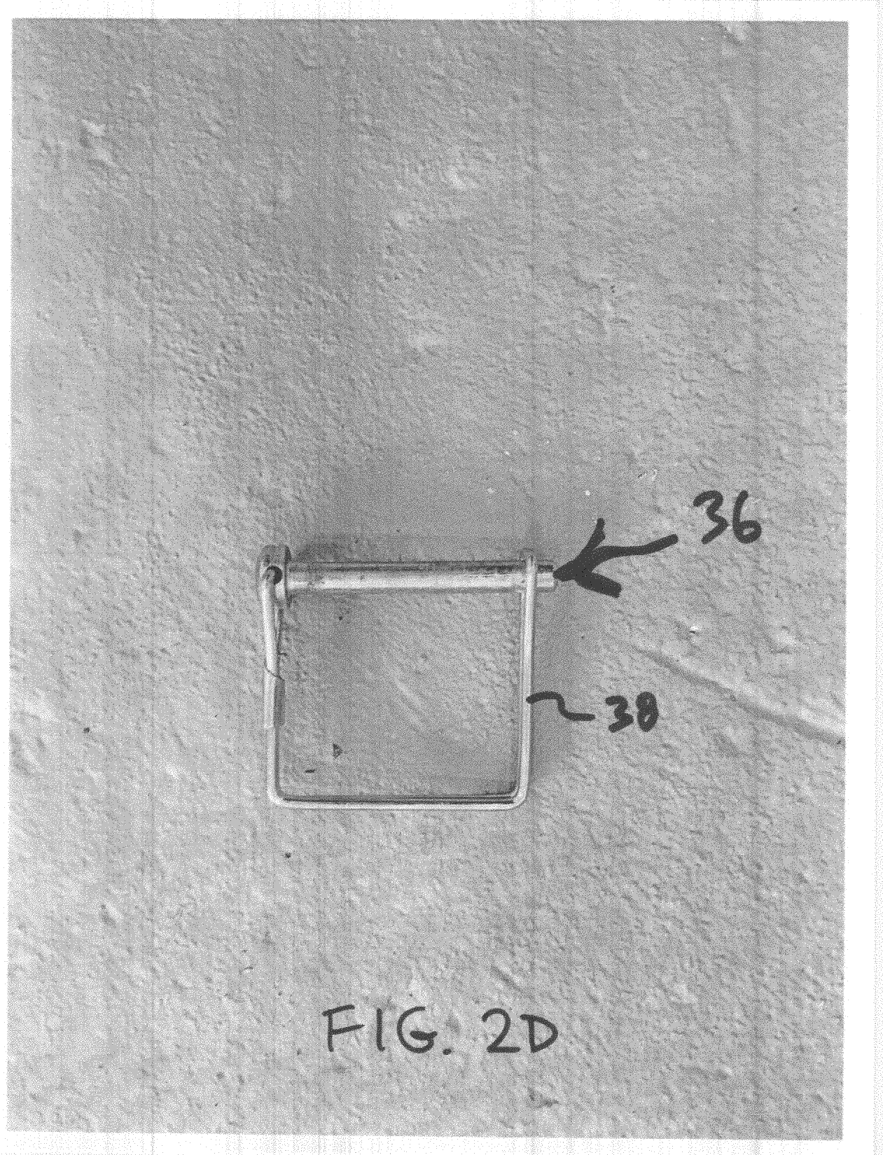

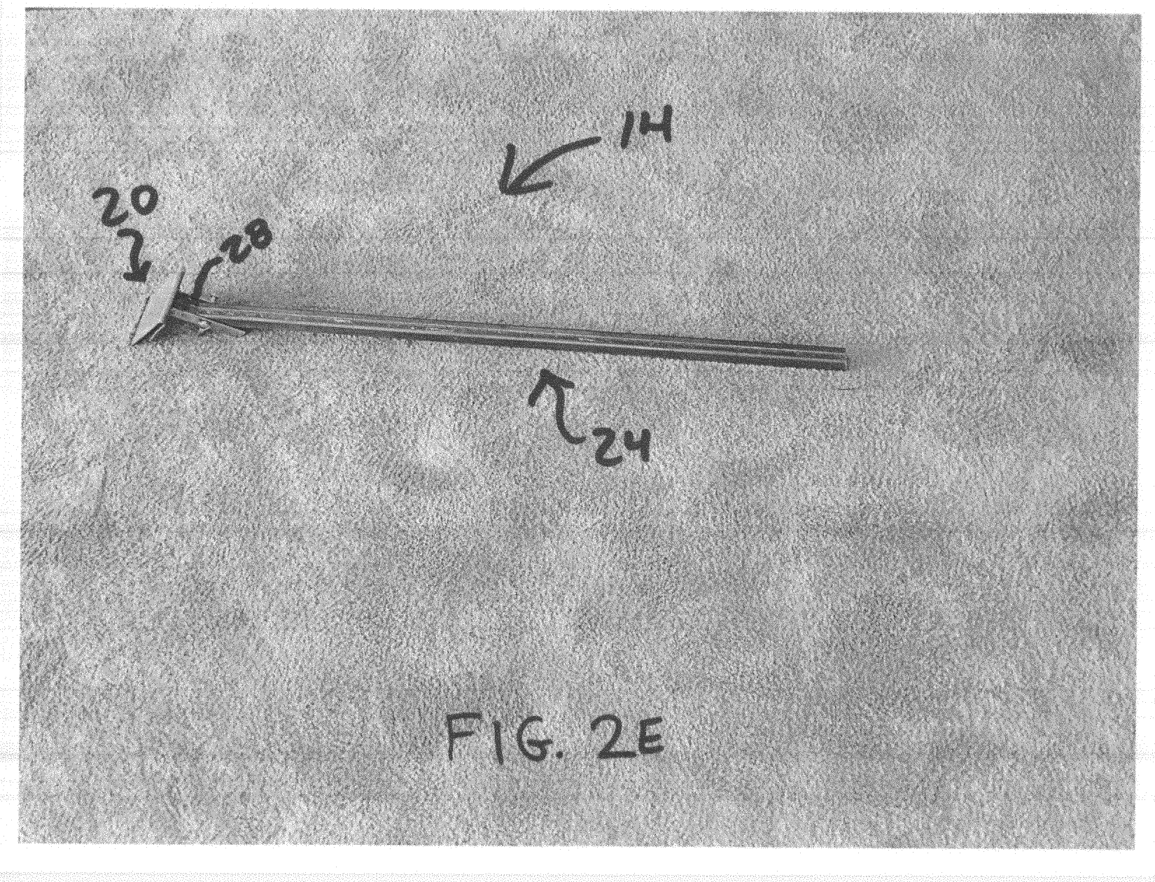

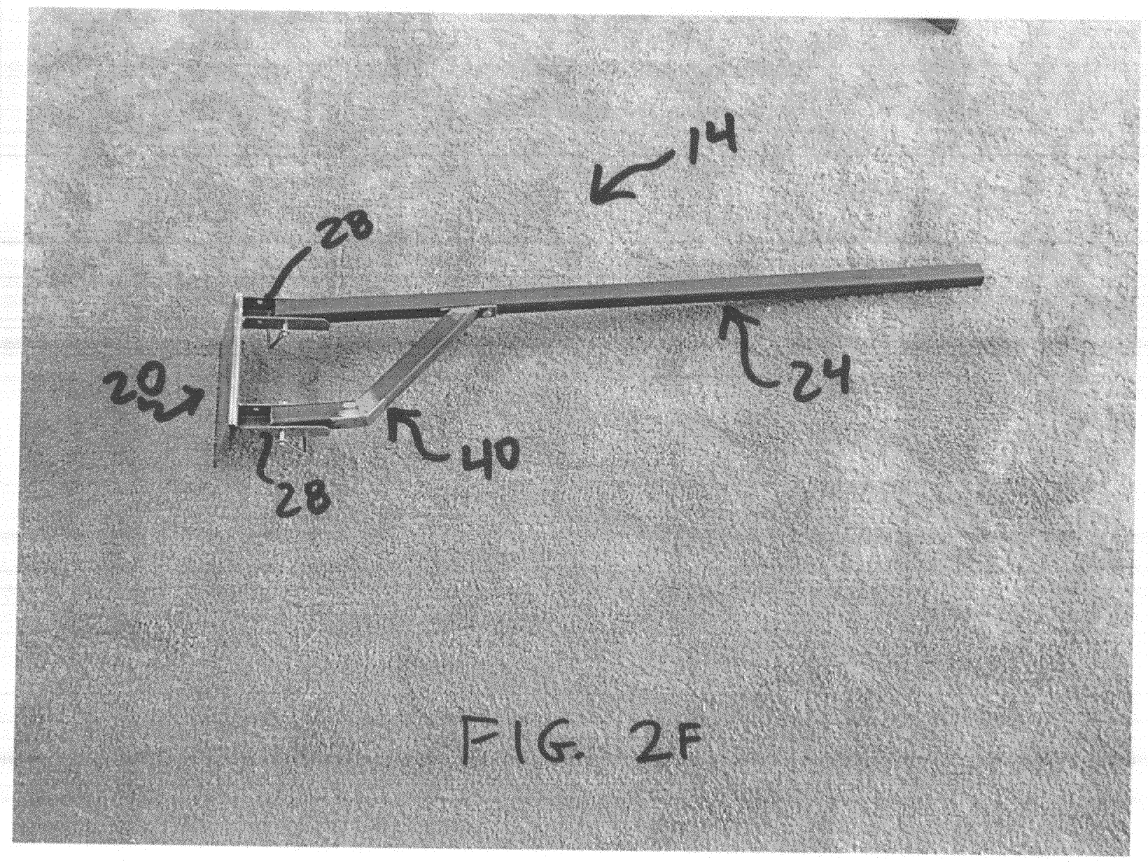

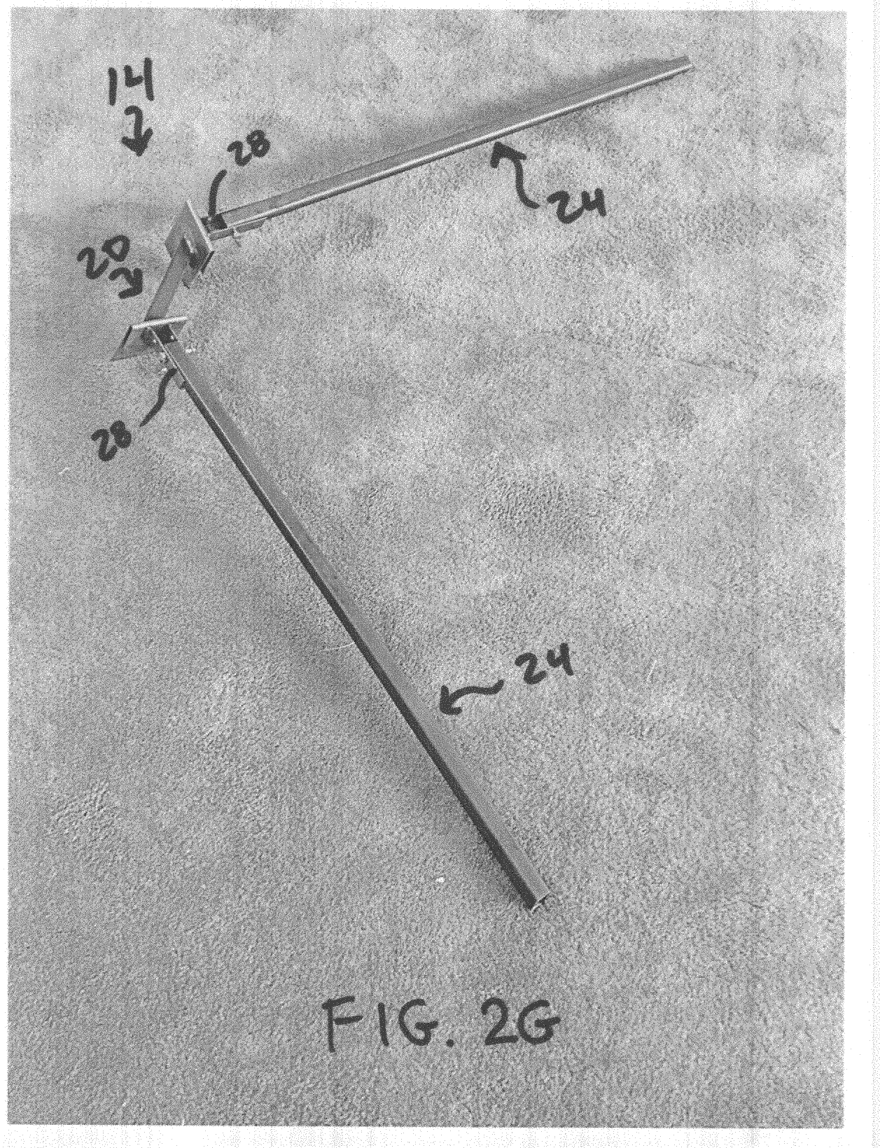

Referring additionally to FIGS. 2A-2G, illustrative details will be discussed by way of non-limiting examples regarding the attachment devices 14. In various embodiments each of the attachment devices 14 includes a bracket 20 that is slidably receivable over a toe kick of the basket 12 and at least one support arm 24 that extends substantially normally from the bracket 20.

In various embodiments, the bracket 20 may define a channel 26 configured to slide over a vertical wall member of the toe kick 22 and a mounting stub 28 that extends substantially normally from the channel 26. It will be appreciated that, as used in all instances herein, it is contemplated that extending “substantially normally” includes extending at an angle above the horizon or above horizontal (such that an angle of extension measured from the top of the basket 12 is less than ninety degrees and an angle of extension measured from the bottom of the basket 12 is greater than ninety degrees). At least one hole 30 is defined in the mounting stub 28 proximate the channel 26. If desired, a temporary anchoring mechanism 32, such as without limitation a set screw or the like, may be used to frictionally engage a vertical wall member of the toe kick 22 to temporarily anchor the bracket 20 to the toe kick 22. The bracket 20 may be made of any suitable material, such as steel, stainless steel, or the like.

In various embodiments, the support arm 24 may be a rectangular tube and may be made of any suitable material. In some embodiments, the support arm may be made of a metal, such as steel, stainless steel, or the like. In some other embodiments, the support arm may be made of a an electrically-non-conductive material (such as without limitation fiberglass or the like) for use contemplated to be in the vicinity of electrical power. In various embodiments, the support arm 24 defines a hole 34 proximate an end of the support arm 24.

In various embodiments, the support arm 24 is removably attachable to its associated bracket 20. In some such embodiments, the support arm 24 may be rotatably removably attachable to its associated bracket 20. For example, the support arm 20 is received in the mounting stub 28 such that the holes 34 line up with desired holes 30. A pin 36, such as a linch pin, is inserted through the aligned holes 30 and 34 and a retaining clip 38 is placed onto the pin 36, thereby rotatably removably attaching the support arm 24 to its associated bracket 20.

Various attachment devices 14 are contemplated, depending upon intended use as described below.

In some embodiments and as shown in FIGS. 2E and 2F, the bracket 20 is configured to be attached to one support arm 24. In such embodiments, the bracket 20 is configured to be attached to one support arm 24 at at least one attachment point. As shown in FIG. 2E, the bracket 20 is configured to be attached to one support arm 24 at one attachment point. Such attachment devices 14 are suitable for use in attaching portions of the flexible cover 16 to sides of the basket 12. As shown in FIG. 2F, the bracket 20 is configured to be attached to one support arm 24 at two attachment points. That is, in such embodiments two mounting stubs 28 extend from the bracket 20. The support arm 24 is removably attached to its associated mounting stub 28 as described above. A breakaway stop member 40 (also referred to as a “dog leg”) is fixedly attached at one end to the support arm 24. The other end of the breakaway stop member 40 is removably attached to its associated mounting stub 28 as described above for the support arms 24. Such attachment devices 14 are suitable for use in attaching portions of the flexible cover 16 to sides of the basket 12 at ends of a coverage area of the flexible cover 16 about a perimeter of the basket 12. It will be appreciated that extra support provided by the breakaway stop member 40 can help prevent collapse of the support arms 24 at ends of the coverage area of the flexible cover 16 in the event that an item is dropped onto the flexible cover 16.

In some embodiments and as shown in FIG. 2G, the bracket 20 is configured to be attached to two support arms 24. Such attachment devices 14 are suitable for use in attaching portions of the flexible cover 16 to corners of the basket 12.

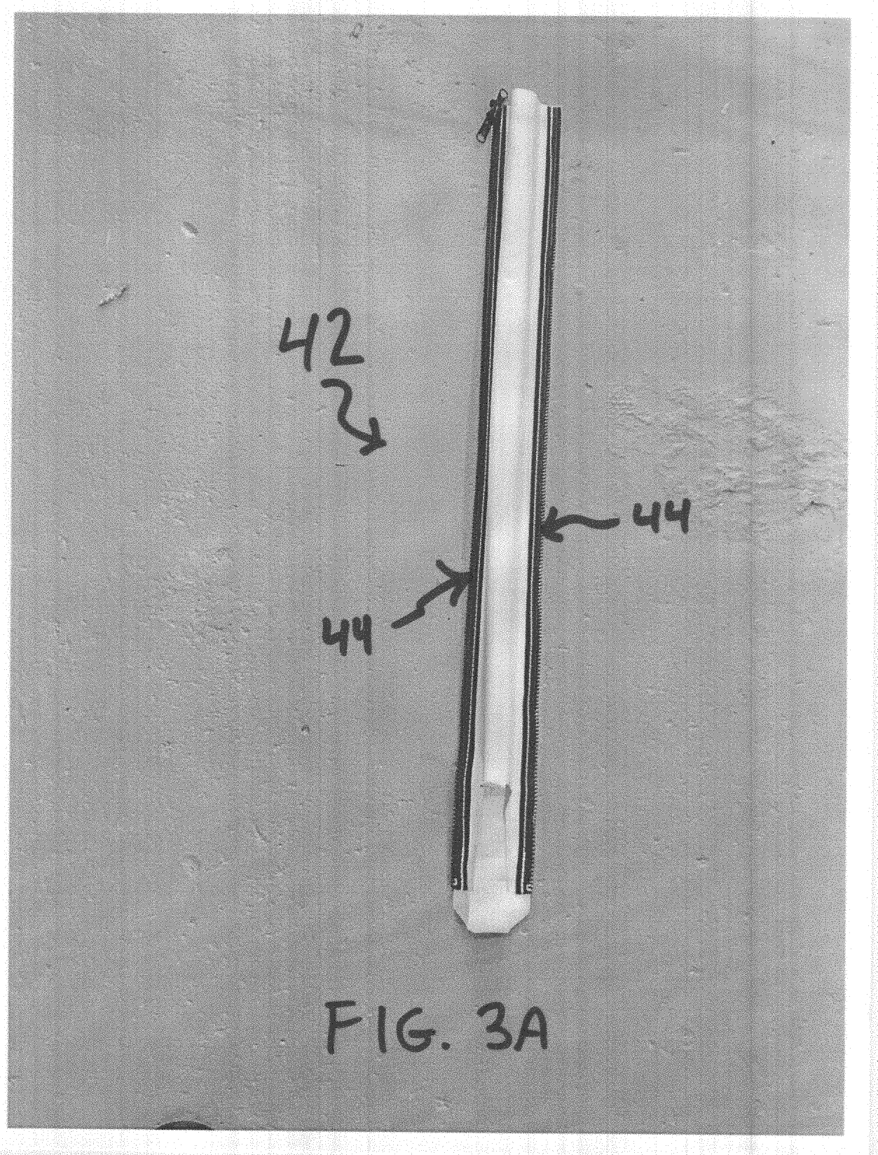

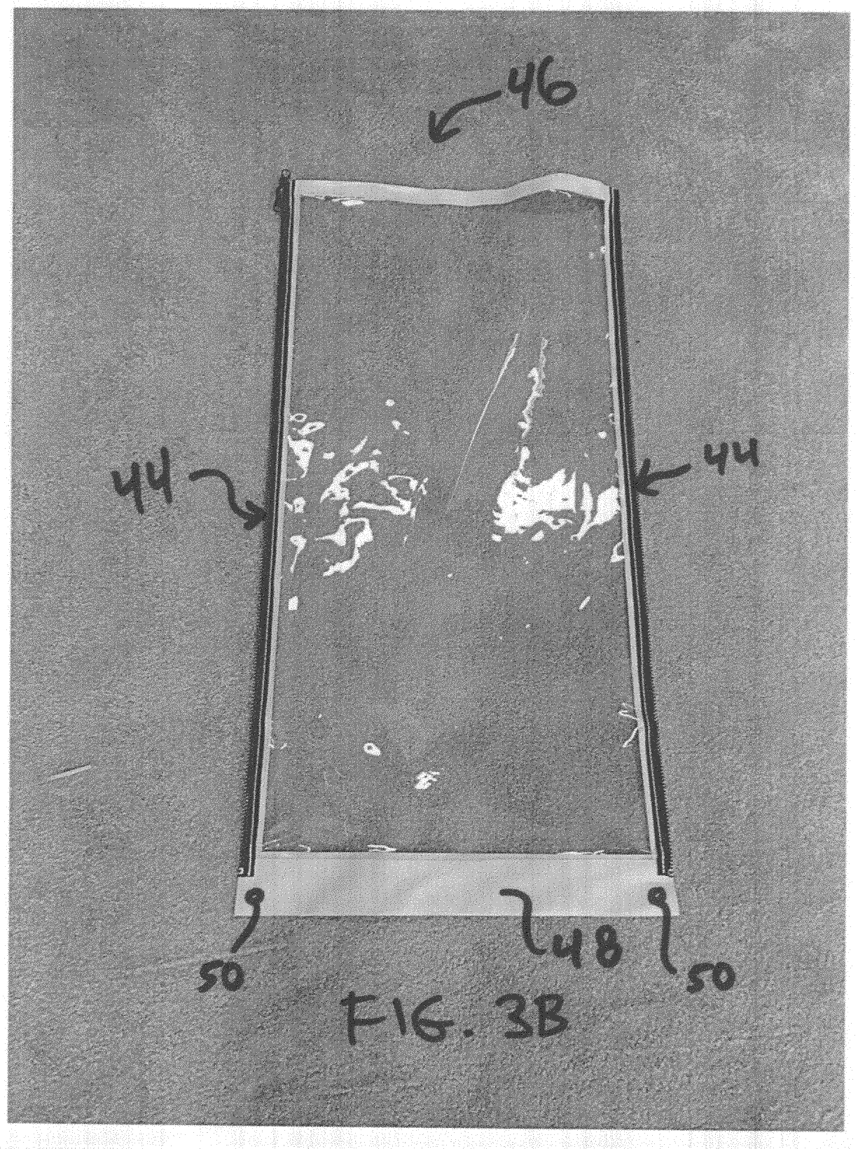

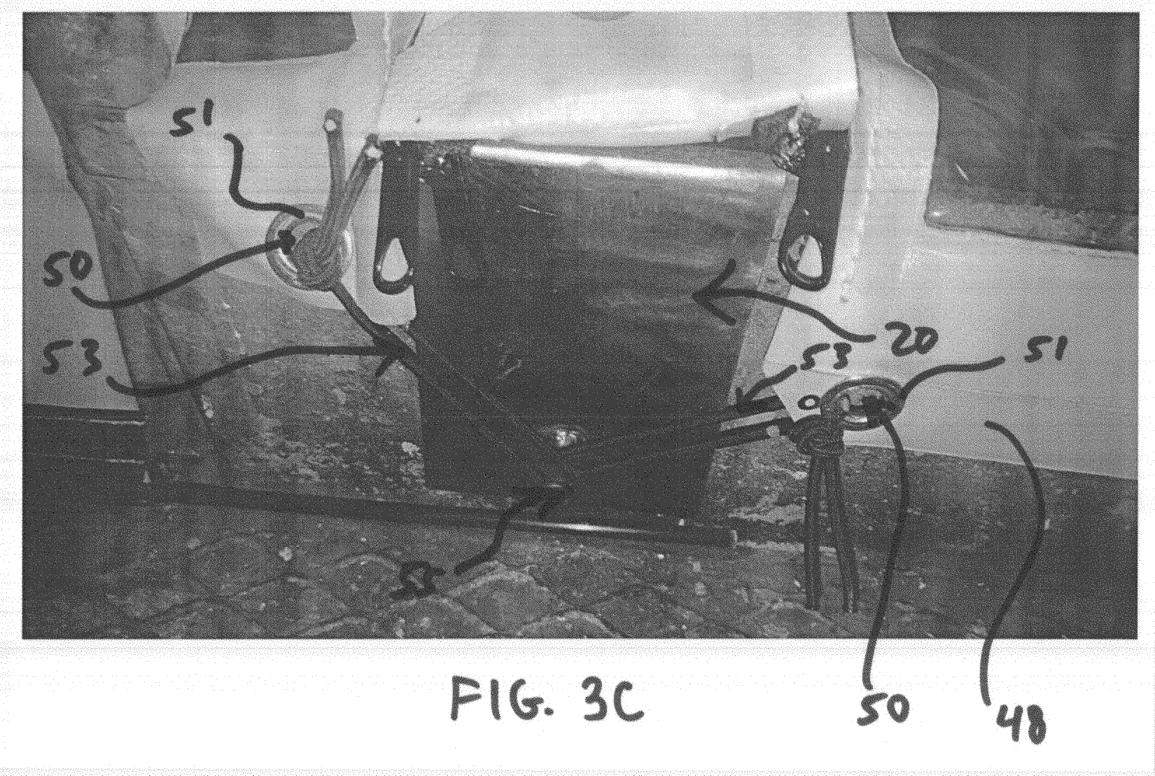

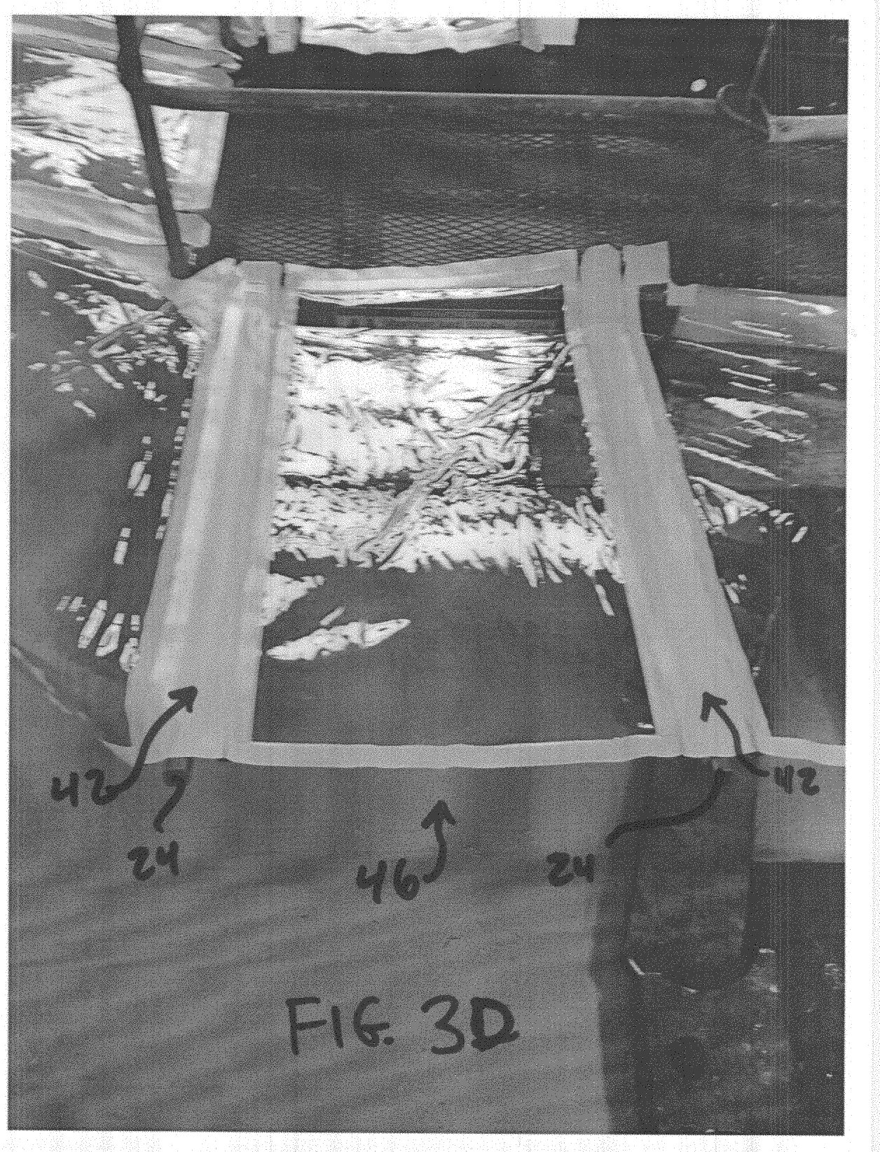

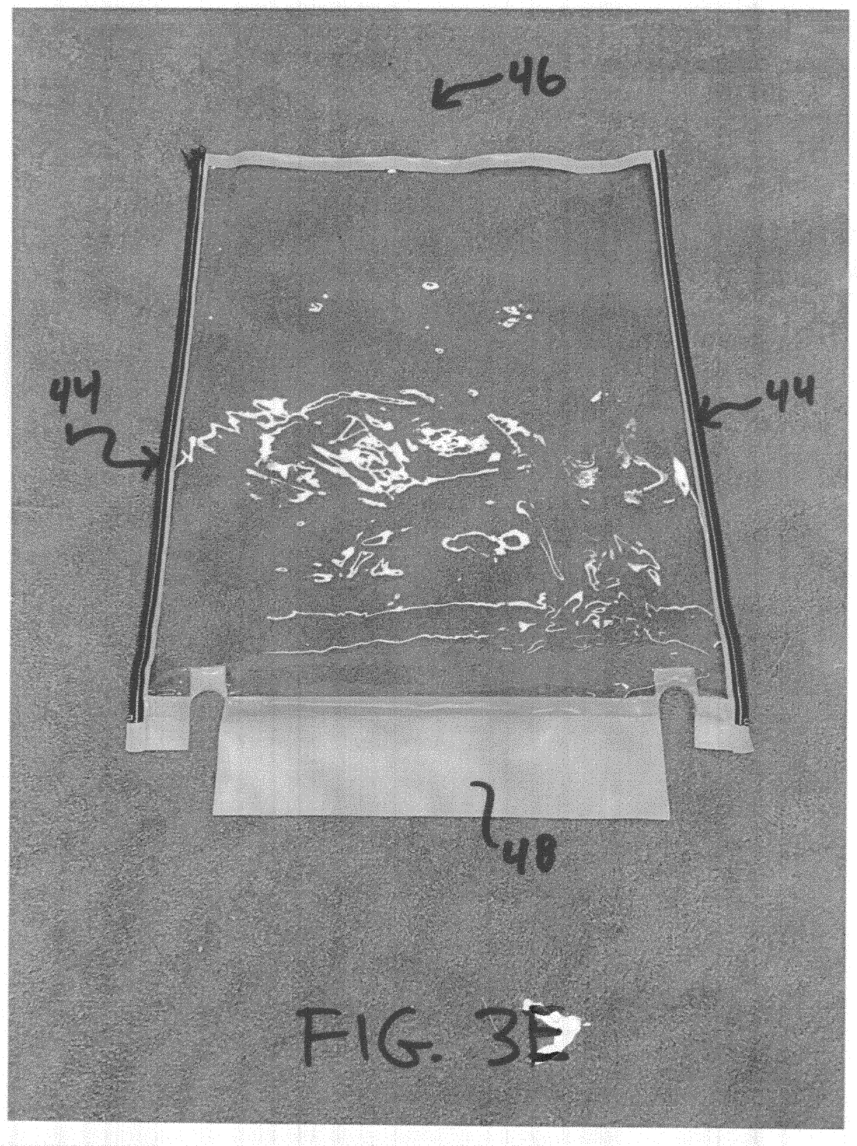

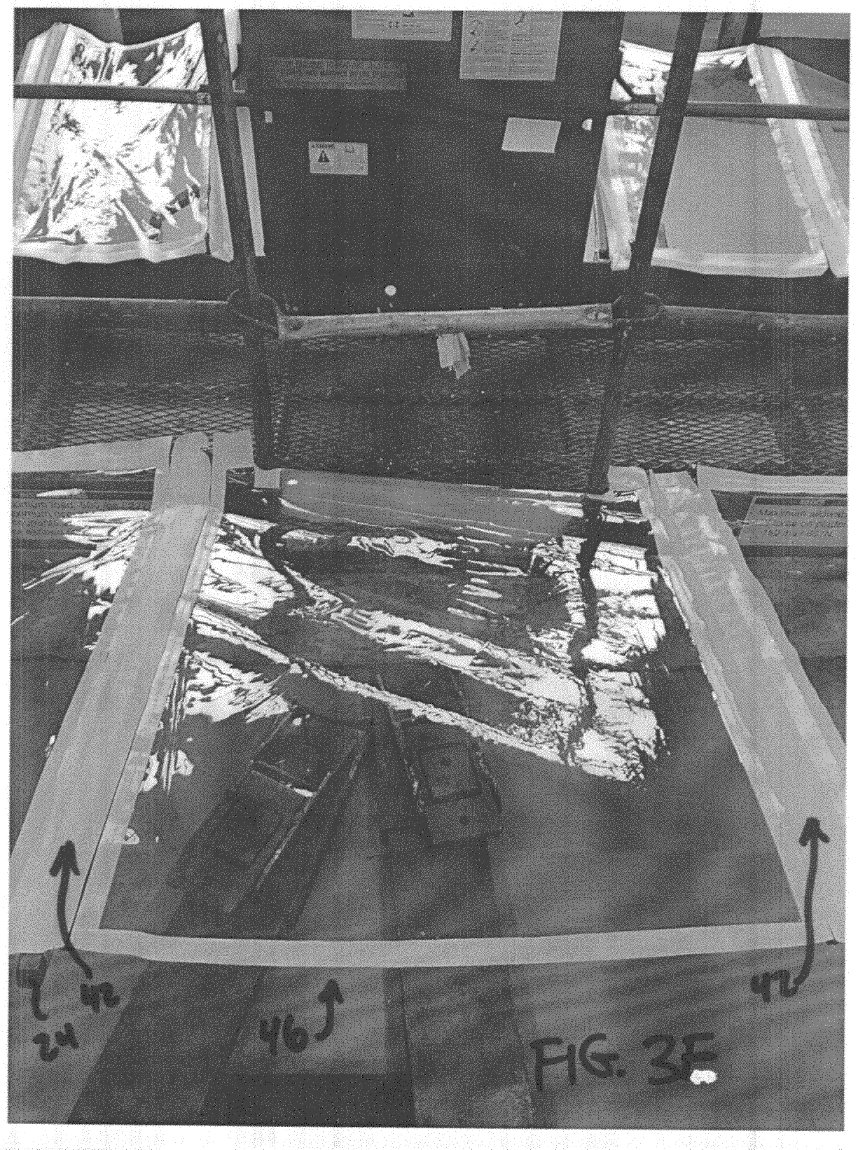

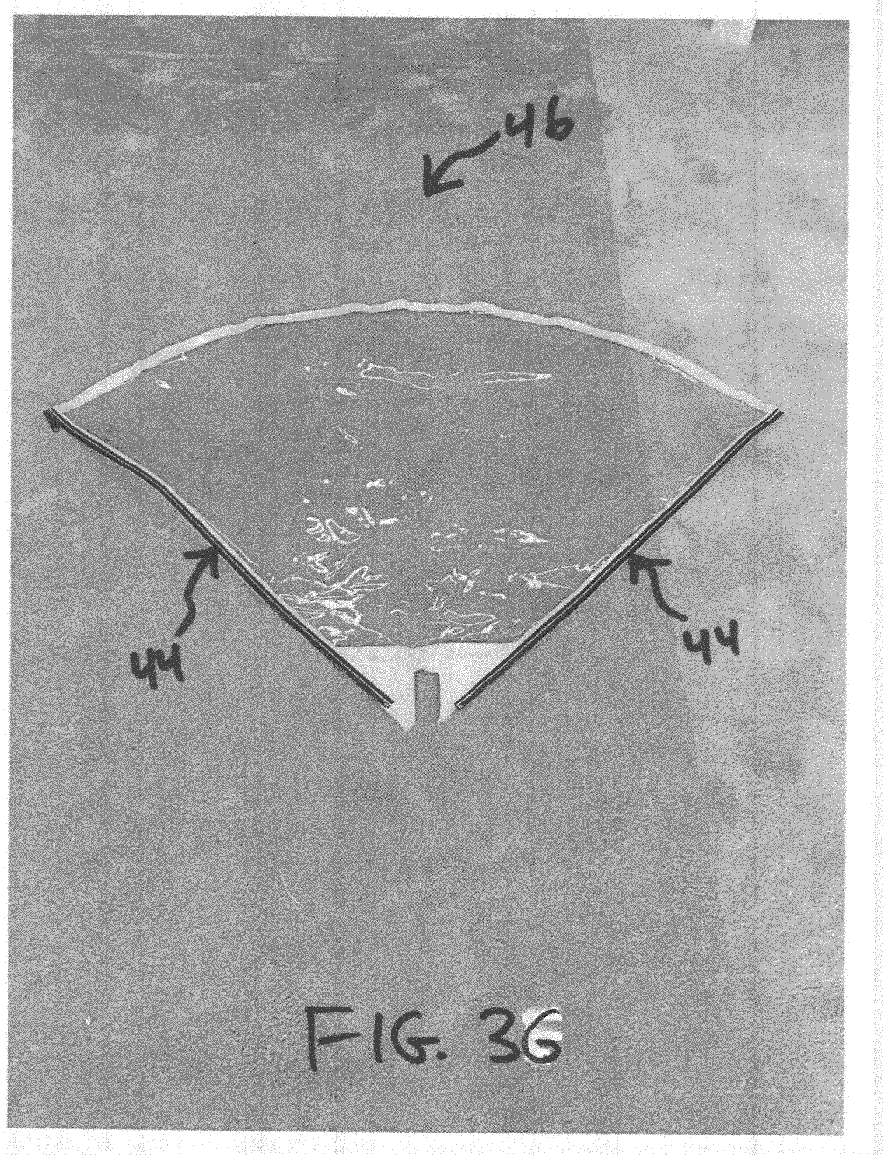

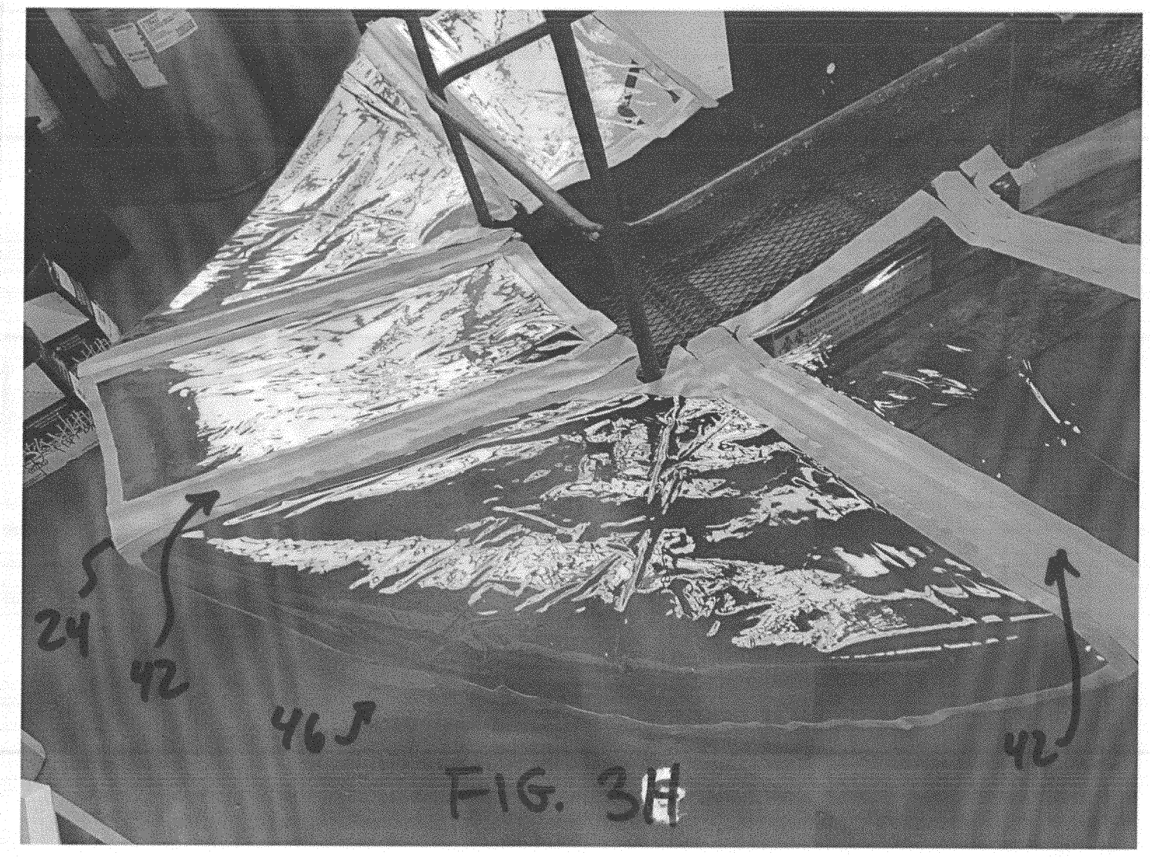

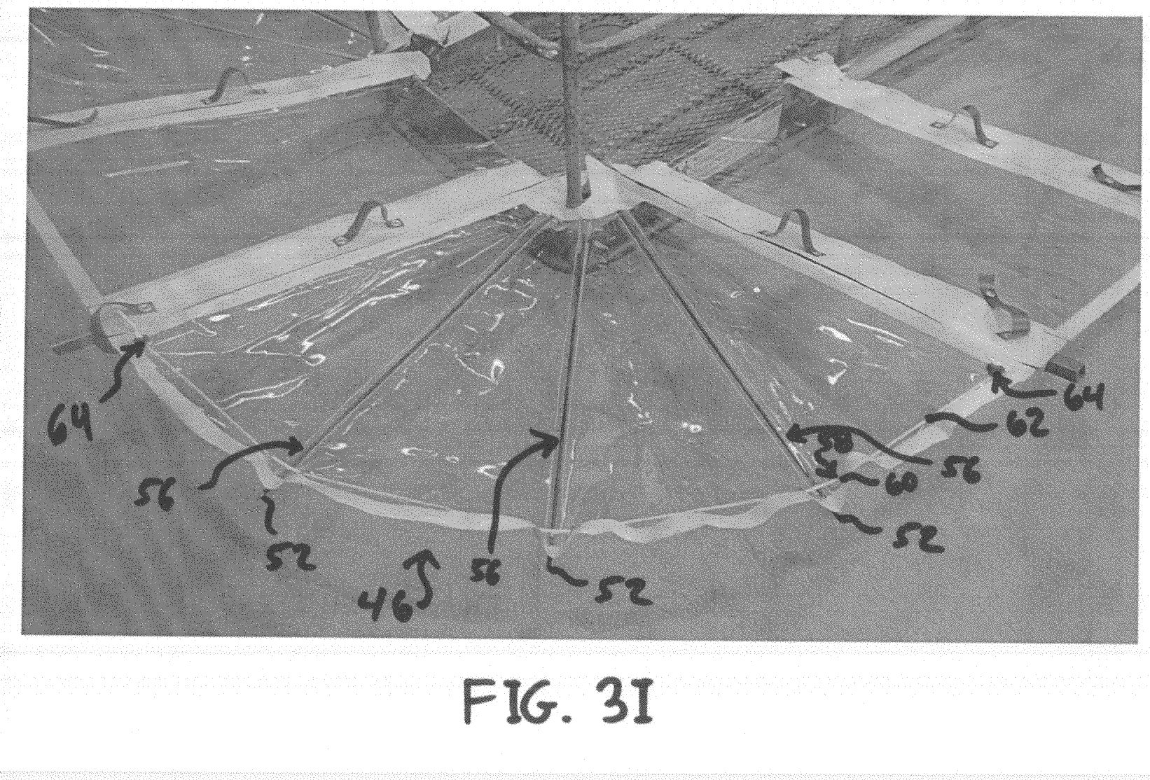

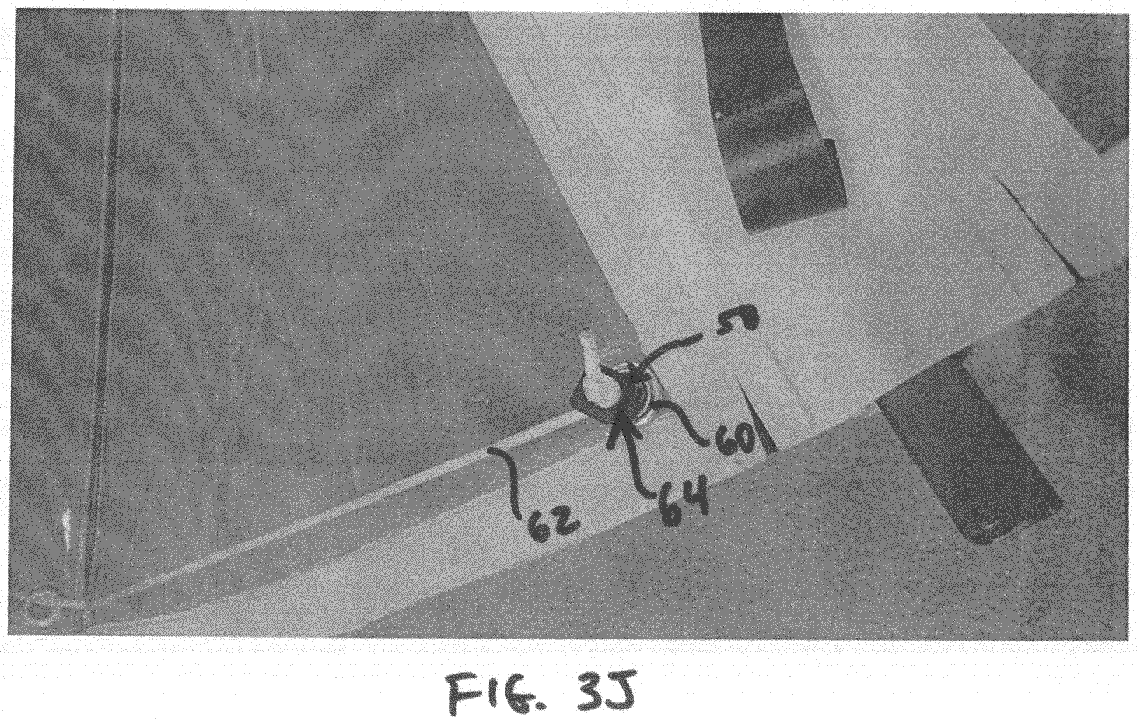

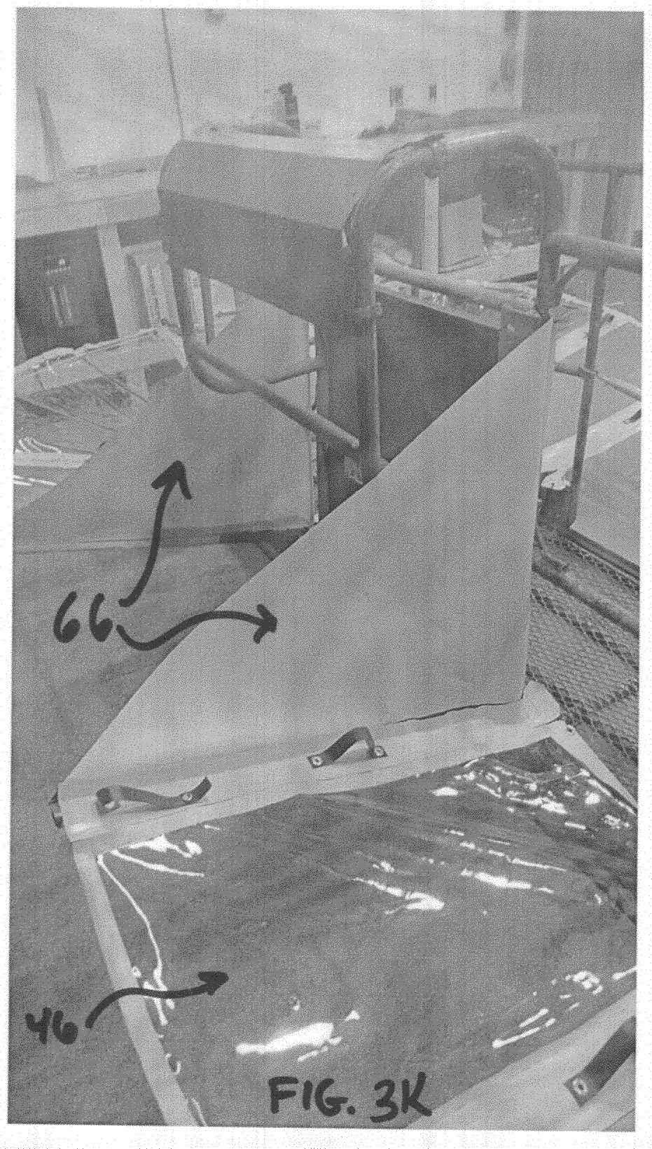

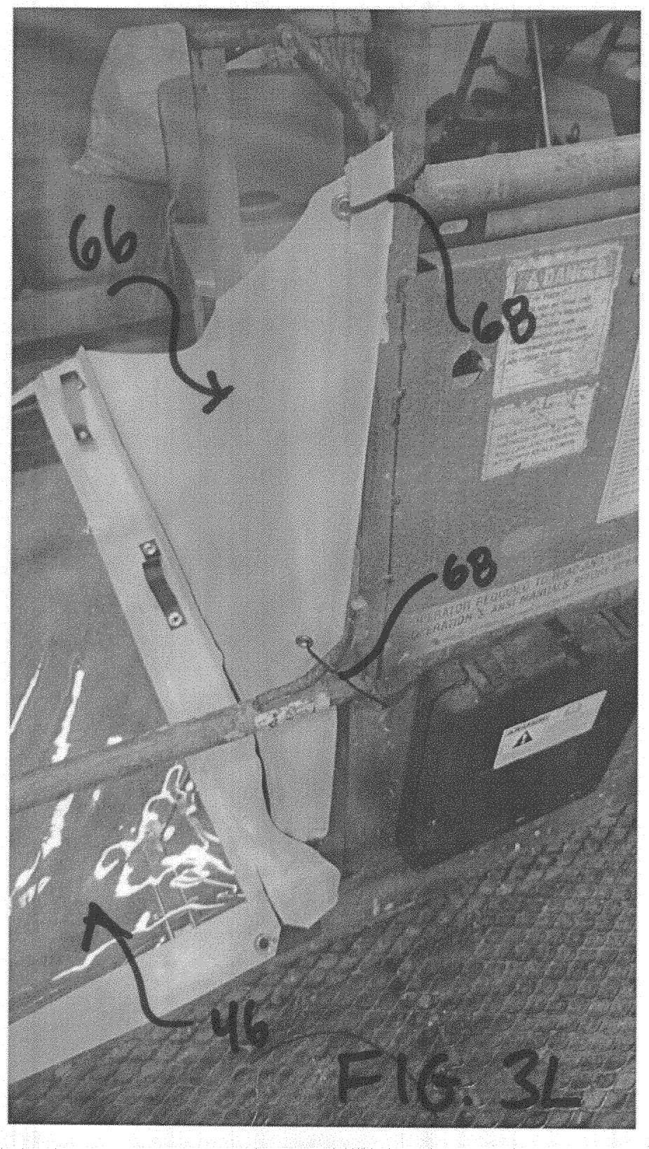

Referring additionally to FIGS. 3A-3G, illustrative details will be discussed by way of non-limiting examples regarding the flexible cover 16.

In various embodiments and as shown in FIG. 3A, a suspension tube 42 is configured to be slidably receivable onto an associated support arm 24. That is, the suspension tube 42 slides onto the support arm 24. The suspension tube 42 may be made of any suitable material, such as without limitation fabric, as desired. It will be appreciated that the fabric on top of the suspension tube 42 need not extend along the entire length of the suspension tube 42. In some embodiments and as shown in FIG. 3A, the fabric on top of the suspension tube 42 does not extend along the entire length of the suspension tube 42. It will be appreciated that, in such embodiments, the suspension tube 42 can fit onto any of the attachment devices 20 (including the attachment device 14 that includes the breakaway stop member 40).

In various embodiments, the suspension tube 42 includes at least one releasable closure device 44. For example and as shown in FIG. 3A, each long side of the suspension tube 42 may include one releasable closure device 44. In various embodiments, the releasable closure device 44 may include a hook-and-loop fastener, snaps, a zipper, or the like. As will be discussed further below, in various embodiments the releasable closure devices 44 can help to provide the weak link discussed above.

It will be appreciated that, in various embodiments, the flexible cover 16 is not provided as one contiguous cover but instead is made from flexible panels 46. To that end and as shown in FIGS. 3B-3G, in various embodiments the flexible cover 16 includes at least one flexible panel 46. Use of the flexible panels 46 can help, in part, provide for the weak link discussed above.

In various embodiments, the flexible panel 46 may be made of any suitable material, such as vinyl, fabric, and the like, and may have any thickness as desired for a particular application. In various embodiments, the material from which the panels 46 are made may be clear, thereby permitting workers to see through the panels 46.

In various embodiments, each long side of the flexible panel 46 includes one of the releasable closure devices 44. The releasable closure devices 44 of the flexible panel 46 are removably attachable to the releasable closure devices 44 of suspension tubes 42 that are slidably received on adjacent support arms 24. As such, the panel 42 is removably attached to the attachment device 14. In some of these embodiments, removability provided by various implementations of the releasable closure devices 44 (such as hook-and-loop fasteners and snaps) can help provide the weak link discussed above. Thus, in various embodiments use of the panels 46 (instead of one contiguous cover) and use of the releasable closure devices 44 to removably attach the panels 46 to the attachment devices cooperate to provide the weak link.

In various embodiments and as shown in FIG. 3C, the panel 46 may include a flap 48 of fabric configured to extend past the toe kick 22 into the basket 12. In such embodiments, if desired the flap 48 may define therein at least one hole 50 that is reinforced by a grommet 51 or the like. If desired, a loop of cord 53 or the like can be inserted through the hole 50 and can be removably attached to an attachment feature 55 (such as a post or the like) of an associated bracket 20, thereby removably attaching the panel 46 to its associated bracket 20.

In various embodiments, the flexible panels 46 may be provided in various sizes and shapes to accommodate different parts of the basket 12. For example and as shown in FIGS. 3B and 3D, the panel 46 may be used along a side of the basket 12. As shown in FIGS. 3E and 3F, the panel 46 may be used adjacent a door of the basket 12. As shown in FIGS. 3G and 3H, the panel 46 may be used adjacent a corner of the basket 12. It will be appreciated that, in such cases, the panel 46 is removably attached to the attachment device shown in FIG. 2G. It will also be appreciated that, if desired, as shown in FIG. 31 optional support members 52 may be provided to help prevent material of the corner panel 46 from sagging. In various embodiments, the support members 52 may be fiberglass rods. In various embodiments, a pocket 56 of material may be formed and attached to the corner panel 46, such as by sewing or radiofrequency (RF) welding, and the support member may be slid into the pocket. In some embodiments and as also shown in FIGS. 3I and 3J, material of the corner bracket 46 may define holes 58 that are reinforced with grommets 60, and a drawstring 62 may be threaded through the grommets 60. The drawstring 62 is releasably held in place with a cord lock 64 at each end of the drawstring 62. It will be appreciated that the drawstring 62 is under tension and, as a result, also helps prevent the material of the corner panel 46 from sagging.

It will be appreciated that the flexible cover 16 need not extend about the entire periphery of the basket 12. That is, panels 46 can be attached just in the vicinity of planned work areas. To that end, in some embodiments the flexible panel 46 may include a vertical flexible panel 66 that is removably attachable (such as with attachment devices 68 like zip ties, cords, or the like) to the upper and lower guardrails 18 of the basket 12 at an end of the flexible cover 16.

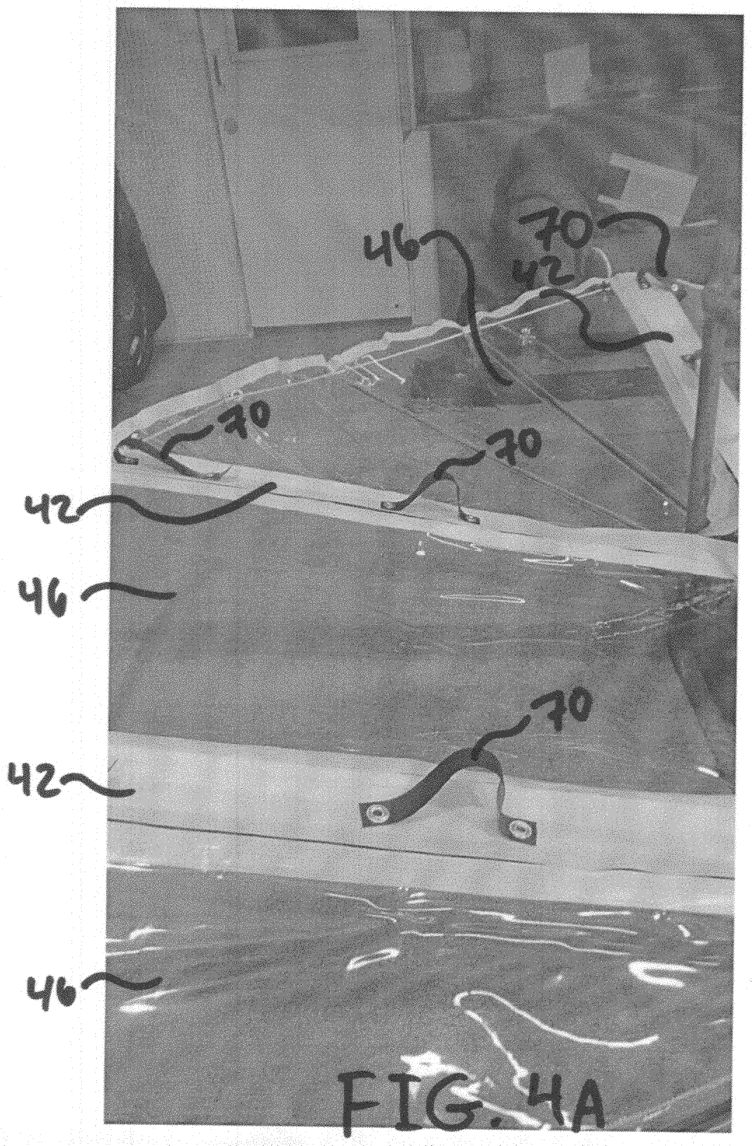

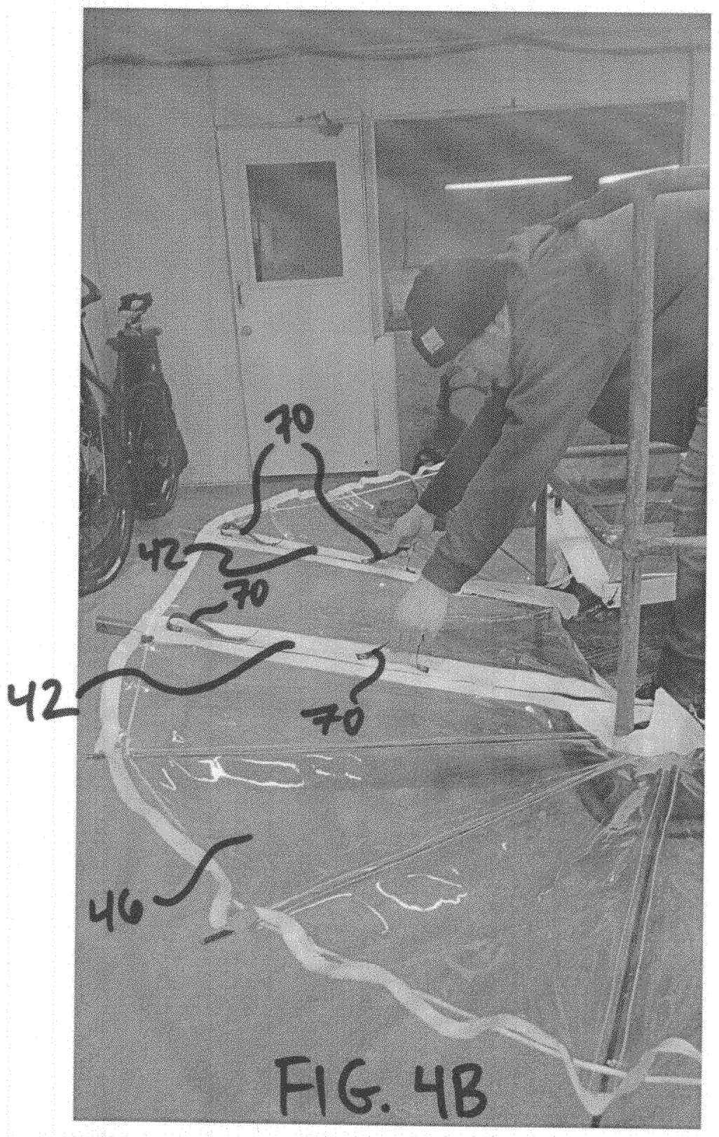

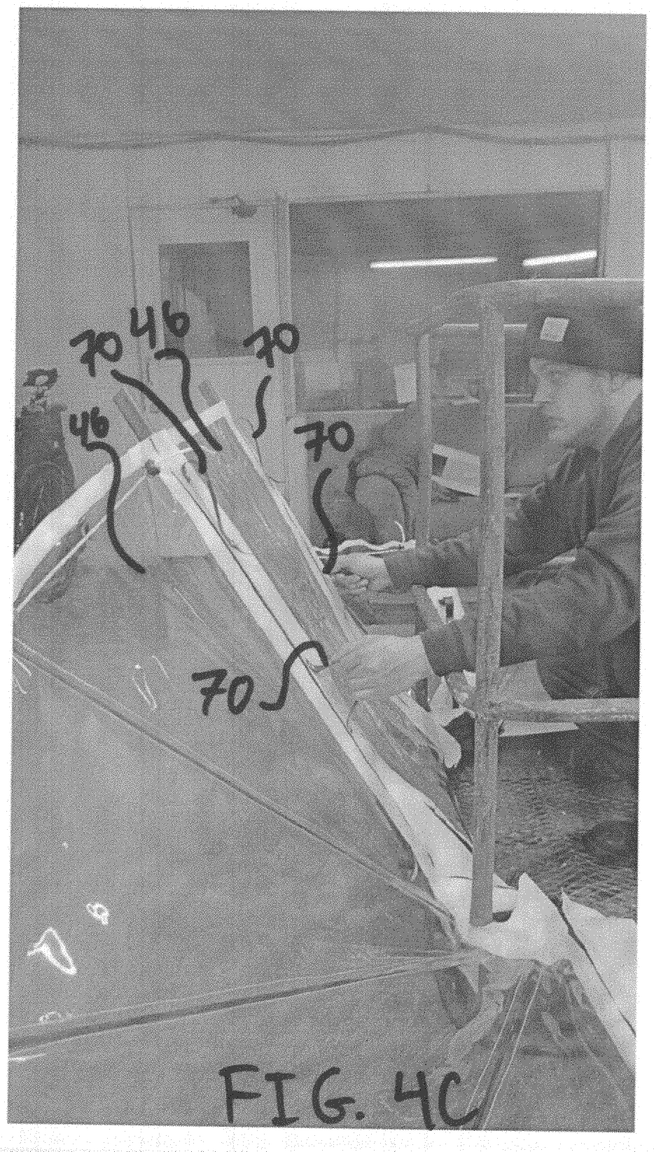

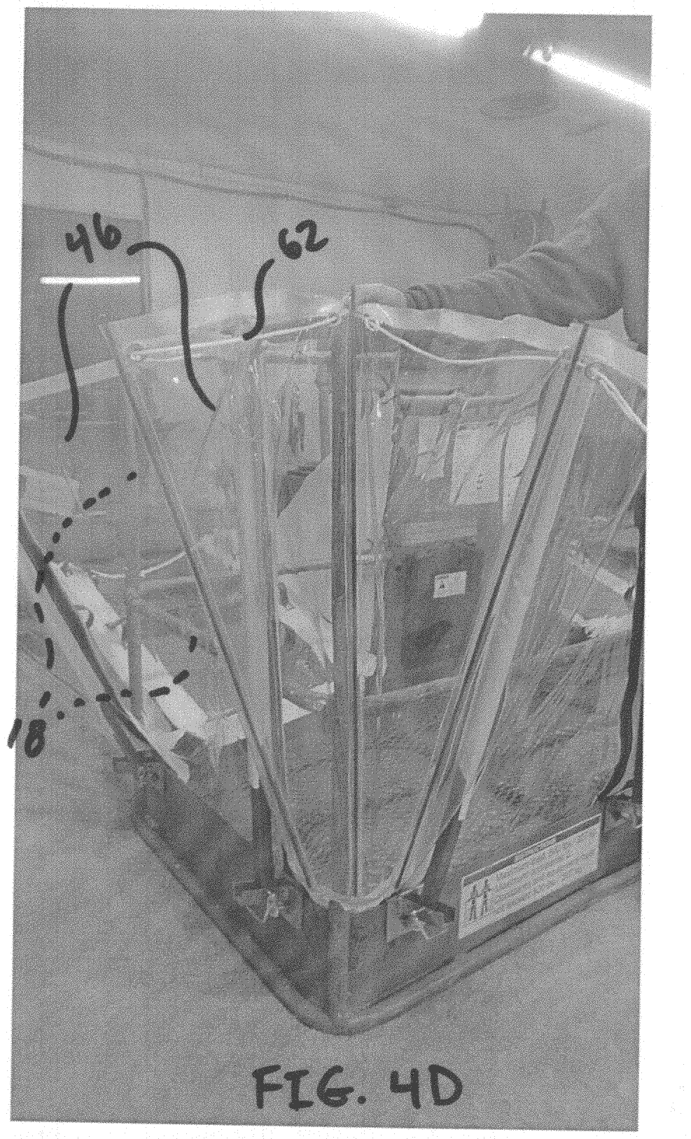

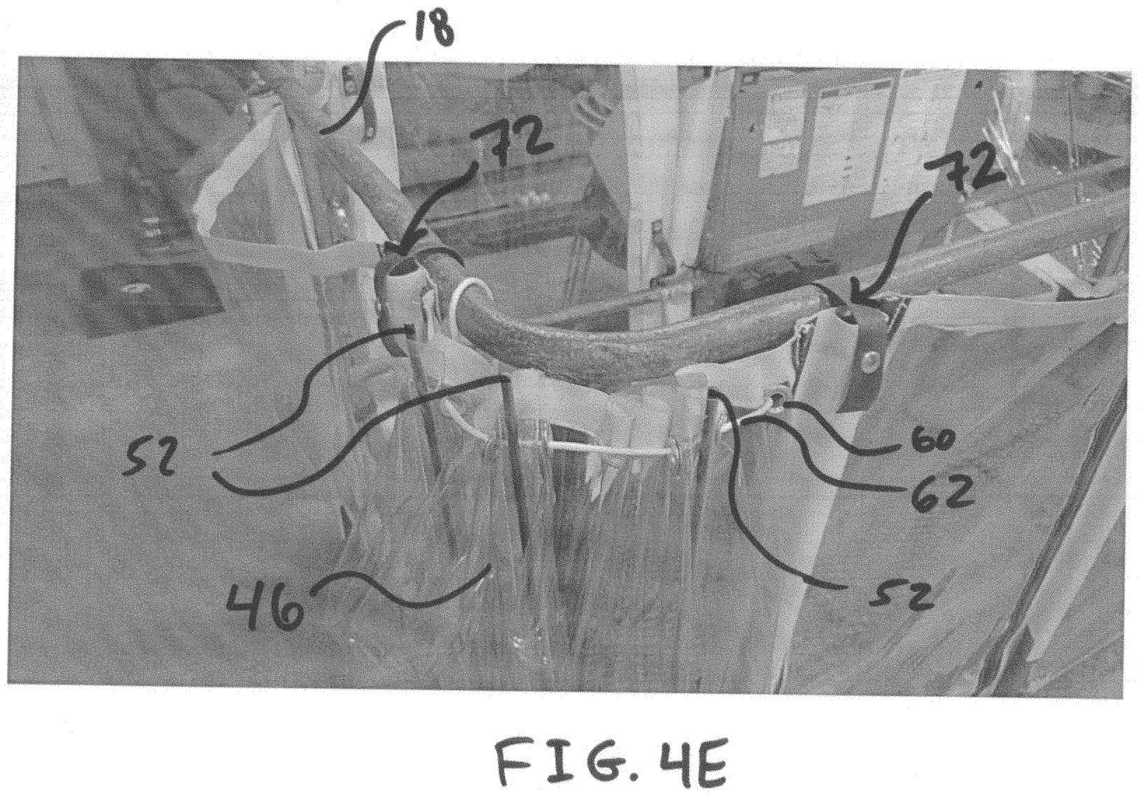

Referring additionally to FIGS. 4A-4E, in various embodiments handles 70 may be provided to permit a user to lift the panels 46 upwardly for temporary attachment to the guardrails 18. It will be appreciated that it would be desirable for the skirt assembly 10 to be disposed in a configuration that is more compact than a fully-deployed configuration (in which the panels 46 are substantially normal to the basket 12) while the basket 12 is being raised and/or lowered and/or while the aerial work platform is being driven, moved, repositioned, or the like. To that end, in some embodiments the handles 70 may be attached to the suspension tubes 42. In some other embodiments, the handles 70 may be attached to the panels 46. Regardless of where the handles 70 are attached, the handles 70 may be attached with rivets, grommets, sewing, RF welding, or the like, as desired for a particular application.

When it is desired to temporarily attach the panels 46 to the guardrails 18, as shown in FIG. 4E one end of the drawstring 62 may be pulled through its cord lock 64 (FIG. 3J) and then held in place with its cord lock 64 (FIG. 3J), thereby gathering together the associated corner panel 46 for lifting. As shown in FIG. 4B, a user grasps the handles 70 and lifts upwardly on the handles 70. As shown in FIG. 4C, a user continues to lift upwardly on the handles 70, thereby causing the panels 46 to assume a more vertical orientation than that shown in FIG. 4B. As shown in FIG. 4D, the panels 46 have been lifted sufficiently such that the panels 46 are oriented and disposed substantially proximate the guardrails 18. As shown in FIG. 4E, the panels 46 are removably attached to the guardrails 18 with attachment devices 72, such as without limitation snaps, hook-and-loop fasteners, and the like.

Now that various embodiments of the skirt assembly 10 have been described, an illustrative method of their attachment to a basket of an aerial work platform will be described by way of nonlimiting examples.

In various embodiments, a non-limiting, illustrative method of attaching a skirt assembly onto a basket of an aerial work platform includes: removably attaching a plurality of attachment devices to a basket of an aerial work platform, each of the plurality of attachment devices being configured to extend outwardly from the basket substantially normally to the basket; and removably attaching a flexible cover to the plurality of attachment devices such that the flexible cover is extendable substantially normally about exterior sides of at least a portion of a basket of an aerial work platform.

In various embodiments, removably attaching a plurality of attachment devices to a basket of an aerial work platform may include slidably receiving a bracket over a toe kick of a basket of an aerial work platform. In various embodiments, the bracket may be temporarily anchored to the toe kick.

In various embodiments, removably attaching a plurality of attachment devices to a basket of an aerial work platform may include extending at least one support arm substantially normally from the bracket. In various embodiments, extending at least one support arm substantially normally from the bracket may include removably attaching the support arm to its associated bracket. In various embodiments, removably attaching the support arm to its associated bracket may include rotatably removably attaching the support arm to its associated bracket.

In various embodiments, a suspension tube may be slidably received onto the support arm. In various embodiments, a flexible panel of the flexible cover may be removably attached to suspension tubes slidably received on adjacent support arms.

In various embodiments, a vertical flexible panel may be removably attached to rails of a basket of an aerial work platform at an end of the flexible cover.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While a number of illustrative embodiments and aspects have been illustrated and discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. A skirt assembly for a basket of an aerial work platform, the skirt assembly comprising:
a plurality of attachment devices removably attachable to a basket of an aerial work platform, each of the plurality of attachment devices being configured to extend outwardly from the basket substantially normally to the basket; and
a flexible cover configured to be removably attachable to the plurality of attachment devices such that the flexible cover is extendable substantially normally about exterior sides of at least a portion of a basket of an aerial work platform.

2. The skirt assembly of claim 1, wherein each of the plurality of the attachment devices includes:
a bracket slidably receivable over a toe kick of a basket of an aerial work platform; and
at least one support arm that extends substantially normally from the bracket.

3. The skirt assembly of claim 2, wherein each support arm is removably attachable to its associated bracket.

4. The skirt assembly of claim 3, wherein each support arm is rotatably removably attachable to its associated bracket.

5. The skirt assembly of claim 2, wherein at least one support arm is made of a material chosen from a metal and a non-electrically-conductive material.

6. The skirt assembly of claim 2, wherein the bracket is configured to be attachable to one support arm.

7. The skirt assembly of claim 6, wherein the bracket is configured to be attachable to one support arm at at least one attachment point.

8. The skirt assembly of claim 2, wherein the bracket is configured to be attachable to two support arms.

9. The skirt assembly of claim 2, further comprising
a suspension tube configured to be slidably receivable onto the support arm.

10. The skirt assembly of claim 9, wherein the suspension tube is made of fabric.

11. The skirt assembly of claim 9, wherein the suspension tube includes at least one releasable closure device.

12. The skirt assembly of claim 11, wherein the releasable closure device includes a closure device chosen from a hook-and-loop fastener, snaps, and a zipper.

13. The skirt assembly of claim 1, wherein the flexible cover includes at least one flexible panel.

14. The skirt assembly of claim 13, wherein the flexible panel is made of a material chosen from vinyl and fabric.

15. The skirt assembly of claim 14, wherein the flexible panel includes a vertical flexible panel removably attachable to rails of a basket of an aerial work platform at an end of the flexible cover.

16. A skirt assembly for a basket of an aerial work platform, the skirt assembly comprising:
a plurality of attachment devices removably attachable to a basket of an aerial work platform, each of the plurality of attachment devices being configured to extend outwardly from the basket substantially normally to the basket, wherein each of the plurality of the attachment devices includes:
a bracket slidably receivable over a toe kick of a basket of an aerial work platform;
and
at least one support arm that extends substantially normally from the bracket; and
a flexible cover configured to be removably attachable to the plurality of attachment devices such that the flexible cover is extendable substantially normally about exterior sides of at least a portion of a basket of an aerial work platform, wherein the flexible cover includes at least one flexible panel made of a material chosen from vinyl and fabric.

17. A method of attaching a skirt assembly to a basket of an aerial work platform, the method comprising:
removably attaching a plurality of attachment devices to a basket of an aerial work platform, each of the plurality of attachment devices being configured to extend outwardly from the basket substantially normally to the basket; and
removably attaching a flexible cover to the plurality of attachment devices such that the flexible cover is extendable substantially normally about exterior sides of at least a portion of a basket of an aerial work platform.

18. The method of claim 17, wherein removably attaching a plurality of attachment devices to a basket of an aerial work platform includes slidably receiving a bracket over a toe kick of a basket of an aerial work platform.

19. The method of claim 18, further comprising:
temporarily anchoring the bracket to the toe kick.

20. The method of claim 17, wherein removably attaching a plurality of attachment devices to a basket of an aerial work platform includes extending at least one support arm substantially normally from the bracket.

21. The method of claim 20, wherein extending at least one support arm substantially normally from the bracket includes removably attaching the support arm to its associated bracket.

22. The method of claim 21, wherein removably attaching the support arm to its associated bracket includes rotatably removably attaching the support arm to its associated bracket.

23. The method of claim 22, further comprising:
slidably receiving a suspension tube onto the support arm.

24. The method of claim 22, further comprising:
removably attaching a flexible panel of the flexible cover to suspension tubes slidably received on adjacent support arms.

25. The method of claim 22, further comprising:
removably attaching a vertical flexible panel to rails of a basket of an aerial work platform at an end of the flexible cover.
